(19) United States
(12) Patent Application Publication
(10) Pub. No.: US 2025/0222293 A1
(43) Pub. Date: Jul. 10, 2025

(54) FIRE EXTINGUISHING SYSTEM

(71) Applicant: AISAN KOGYO KABUSHIKI KAISHA, Obu-shi (JP)

(72) Inventor: Gyuseung CHOI, Nagoya-shi (JP)

(21) Appl. No.: 19/009,627

(22) Filed: Jan. 3, 2025

(30) Foreign Application Priority Data
Jan. 9, 2024 (JP) 2024-001455
Apr. 1, 2024 (JP) 2024-058771

(51) Int. Cl. A62C 3/07; A62C 37/14

(52) U.S. Cl. CPC A62C 3/07; A62C 37/14

(57) ABSTRACT

A fire extinguishing system configured to extinguish a battery fire is provided, and the system may include: a case accommodating a battery and including a liquid passage arranged around the battery, an inlet port configured to introduce extinguishing liquid into the liquid passage, and a discharge port configured to discharge the extinguishing liquid within the liquid passage toward the battery; and sealing which seals the outlet, in which the sealing melts at a temperature equal to or higher than a predetermined melting temperature to open the discharge port.

### REFERENCE TO RELATED APPLICATIONS

This application claims priority from Japanese Patent Application No. 2024-001455 filed on Jan. 9, 2024 and No. 2024-058771 filed on Apr. 1, 2024. The entire content of the priority application is incorporated herein by reference.

### TECHNICAL FIELD

The art disclosed herein relates to a fire extinguishing system.

### BACKGROUND ART

Japanese Patent Application Publication No. 2022-192000 describes a fire extinguishing device for an electric vehicle. The fire extinguishing device in Japanese Patent Application Publication No. 2022-192000 includes: a water passage tube disposed on a lid of a battery pack mounted in the electric vehicle; and a fire extinguishing water tube disposed outside the battery pack and within the electric vehicle and having one end coupled to the water passage tube and another end coupled to a fire hose in/on a vehicle body of the electric vehicle. Further, the fire extinguishing device in Japanese Patent Application Publication No. 2022-192000 includes a discharge port configured to discharge the fire extinguishing water that is fed into the water passage tube and moves therein toward a battery module disposed below the lid.

### SUMMARY

In the fire extinguishing device of Japanese Patent Application Publication No. 2022-192000, the discharge port is opened in advance, and thus the extinguishing water may be discharged from the discharge port toward the battery module even when there is no battery fire. Due to this, the extinguishing water may be discharged toward the battery module when it is not intended, as a result of which the battery may be wet with the extinguishing water.

The present teachings provide an art configured to extinguish a battery fire and also suppress extinguishing liquid from being discharged toward the battery when there is no battery fire.

A first aspect of the present art relates to a fire extinguishing system configured to extinguish a battery fire. The fire extinguishing system may comprise: a case accommodating a battery and including a liquid passage arranged around the battery, an inlet port configured to introduce extinguishing liquid into the liquid passage, and a discharge port configured to discharge the extinguishing liquid within the liquid passage toward the battery; and sealing which seals the outlet, wherein the sealing melts at a temperature equal to or higher than a predetermined melting temperature to open the discharge port.

In a battery, fire may occur when the battery is excessively heated while the battery is being charged, for example. According to the above configuration, when a battery fire occurs, the sealing is heated to a significantly high temperature and melts, as a result of which the discharge port is opened, and the extinguishing liquid within the liquid passage is discharged from the discharge port toward the battery. Due to this, the battery fire can be extinguished. In the meantime, when there is no battery fire, the discharge port is kept sealed by the sealing, and the extinguishing liquid within the liquid passage can be suppressed from being discharged toward the battery.

In a second aspect, in addition to the first aspect, the fire extinguishing system may further comprise: an inlet passage connected to the liquid passage via the inlet port; and an external device configured to introduce the extinguishing liquid into the liquid passage via the inlet passage and the inlet port.

According to such configuration, when a battery fire occurs, the extinguishing liquid can be additionally introduced from the external device into the liquid passage. Due to this, fire extinguishing capability can be improved.

In a third aspect, in addition to the second aspect, the fire extinguishing system may further comprise: a valve configured to open and close the inlet passage.

According to such configuration, by closing the valve when there is no battery fire, the extinguishing liquid within the liquid passage can be suppressed from flowing out. Also, when a battery fire occurs, the valve can be opened and the extinguishing liquid can be introduced through the inlet passage into the liquid passage. Due to this, fire extinguishing capability can be improved.

In a fourth aspect, in addition to the second or third aspect, the external device may further comprise a charging device configured to charge the battery.

According to such configuration, when there is no battery fire, the battery can be charged by the external device.

In a fifth aspect, in addition to the above-mentioned fourth aspect, the fire extinguishing system may further comprise: a temperature sensor configured to detect a temperature of the battery. The external device may introduce the extinguishing liquid into the liquid passage when the charging device charges the battery. When charging the battery, the charging device may be configured to charge the battery in one of a normal charging mode and a rapid charging mode in which the battery is charged more quickly than in the normal charging mode, and the charging device may charge the battery in the rapid charging mode when the temperature detected by the temperature sensor is within a predetermined threshold temperature range, and may charge the battery in the normal charging mode when the temperature detected by the temperature sensor is outside the predetermined threshold temperature range.

The battery tends to have a greater allowable power for charging when the temperature is within the threshold temperature range and have a smaller allowable power for charging when the temperature is outside the threshold temperature range. According to the above configuration, the battery is charged in the rapid charging mode when the allowable power for charging is great, by which the battery can be effectively charged. Contrary to this, even if the battery is charged in the rapid charging mode when the allowable power for charging of the battery is small, energy loss would occur. According to the above configuration, however, because the battery is charged in the normal charging mode when the allowable power for charging of the battery is small, the wasteful energy loss can be reduced and thus the battery can be effectively charged.

In a sixth aspect, in addition to the above-mentioned fifth aspect, when the charging device charges the battery in the normal charging mode, the external device may introduce the extinguishing liquid into the liquid passage at a first flow rate, and when the charging device charges the battery in the rapid charging mode, the external device may introduce the extinguishing liquid into the liquid passage at a second flow rate that is greater than the first flow rate.

When the battery is charged in the rapid charging mode, the temperature of the battery tends to be higher because high power is supplied to the battery. Contrary to this, when the battery is charged in the normal charging mode, heat generation in the battery tends to be suppressed. According to such configuration, the temperature of the battery can be suppressed low because a greater amount of the extinguishing liquid can be introduced when the temperature of the battery is higher. Contrary to this, when the heat generation in the battery is suppressed, a small amount of the extinguishing liquid is introduced, as a result of which the extinguishing liquid can be suppressed from being wastefully consumed.

In a seventh aspect, in addition to the first or second aspect, the fire extinguishing system may further comprise a thermal device. The thermal device may comprise: a recovery hose configured to recover the extinguishing liquid led out from the liquid passage; a heat exchanger configured to exchange heat between the extinguishing liquid recovered by the recovery hose and heat medium of the thermal device; and a pump configured to pump the extinguishing liquid to the heat exchanger through the recovery hose.

The extinguishing liquid introduced into the liquid passage disposed around the battery is heated by the heat of the battery. According to such configuration, the heat medium of the thermal device can be heated by using the heat of the extinguishing liquid heated by the heat of the battery. Also, the extinguishing liquid can be cooled. Alternatively, the extinguishing liquid can be heated using the heat of the heat medium of the thermal device. Due to this, the temperature of the battery can be controlled to a temperature suitable for charging.

In an eight aspect, in addition to the fourth aspect, the charging device may charge the battery using renewable energy. According to such configuration, the renewable energy can be effectively utilized, and thus power efficiency can be improved.

### BRIEF DESCRIPTION OF DRAWINGS

FIG. 1 schematically illustrates a fire extinguishing system according to a first embodiment.

FIG. 2 illustrates a cross-sectional view schematically depicting a case and a liquid passage according to the first embodiment.

FIG. 3 illustrates a top view schematically depicting the case and the liquid passage according to the first embodiment.

FIG. 4 schematically illustrates a fire extinguishing system according to a second embodiment.

FIG. 5 illustrates a cross-sectional view schematically depicting a case and a liquid passage according to the second embodiment.

FIG. 6 illustrates a top view schematically depicting the case and the liquid passage according to the second embodiment.

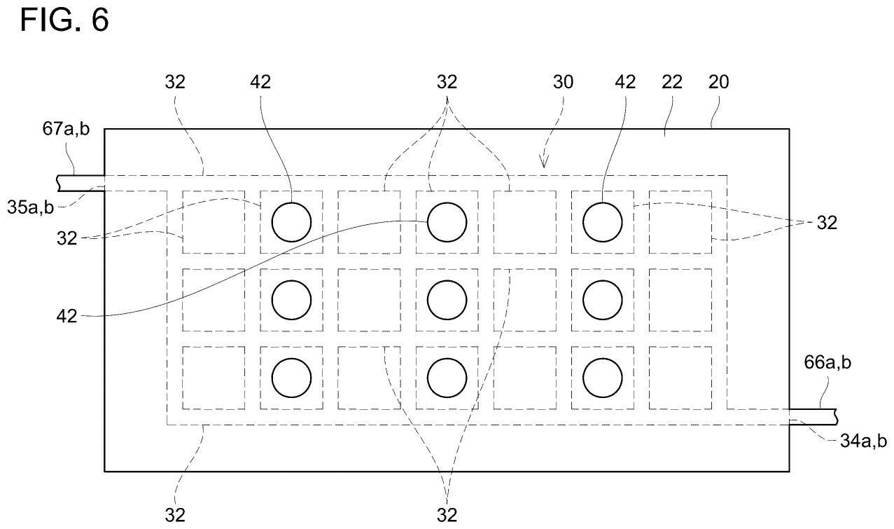

### DETAILED DESCRIPTION

### First Embodiment

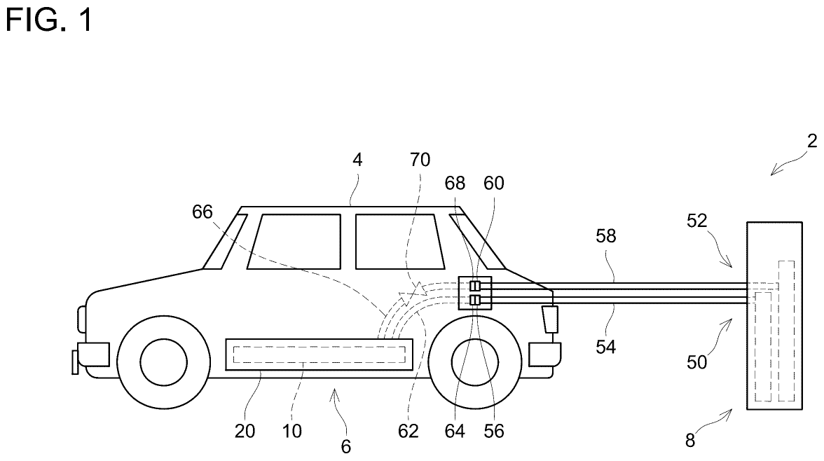

A fire extinguishing system according to a first embodiment will be described with reference to drawings. As illustrated in FIG. 1, a fire extinguishing system 2 according to the first embodiment comprises an internal device 6 mounted in a vehicle 4 and an external device 8 not mounted in the vehicle 4. The vehicle 4 in which the internal device 6 is mounted is an electric vehicle such as electric car or a hybrid car.

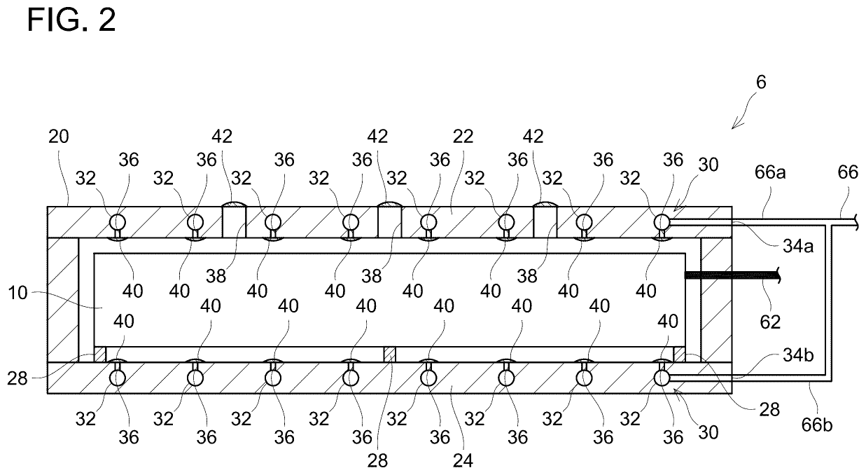

As illustrated in FIG. 2, the internal device 6 comprises a battery 10 mounted in the vehicle 4 and a case 20 accommodating the battery 10. The internal device 6 comprises a charging cable 62 connected to the battery 10 and an inlet passage 66 connected to the case 20. A downstream end of the inlet passage 66 branches into two passages 66a, 66b, and the one passage 66a is connected to a top surface member 22 of the case 20 and the other passage 66b is connected to a bottom surface member 24 of the case 20.

The battery 10 is for example a rechargeable secondary battery such as a lithium-ion battery and nickel-hydrogen battery. The battery 10 is charged by the external device 8 via the charging cable 62. The battery 10 is an assembly of plural small batteries, but the assembly of the plural batteries will be referred to as the battery 10 in the present teachings. The battery 10 is a battery for traveling of the vehicle 4 and supplies power stored therein to a traction motor of the vehicle 4 (not illustrated). The battery 10 may generate heat when it is being charged, for example. Also, the battery 10 may be significantly hot and may catch fire due to the excessive heat, for example when it is under rapid charging.

The charging cable 62 for charging the battery 10 has one end connected to the battery 10. Another end of the charging cable 62 is for example secured to a body of the vehicle 4. A charging connector 64 is attached to the other end of the charging cable 62. A power transmission connector 56 of the external device 8 is connected to the charging connector 64.

The case 20 accommodating the battery 10 is constituted of a metal such as an aluminum alloy. The case 20 may be constituted of a material containing a carbon fiber. Alternatively, the case 20 may be constituted of a combination of these materials. The battery 10 is arranged within the case 20, and the case 20 covers a part or an entirety of the battery 10. The battery 10 and the case 20 are arranged for example beneath a floor and/or seat(s) of the vehicle 4.

As illustrated in FIG. 2, the case 20 comprises for example the top surface member 22 covering a top surface of the battery 10 and the bottom surface member 24 covering a bottom surface of the battery 10. Also, the case 20 comprises a plurality of support members 28 supporting the battery 10. The plurality of support members 28 is disposed on the bottom surface member 24 of the case 20. Additionally, the case 20 may for example comprise side surface member(s) and/or column member(s).

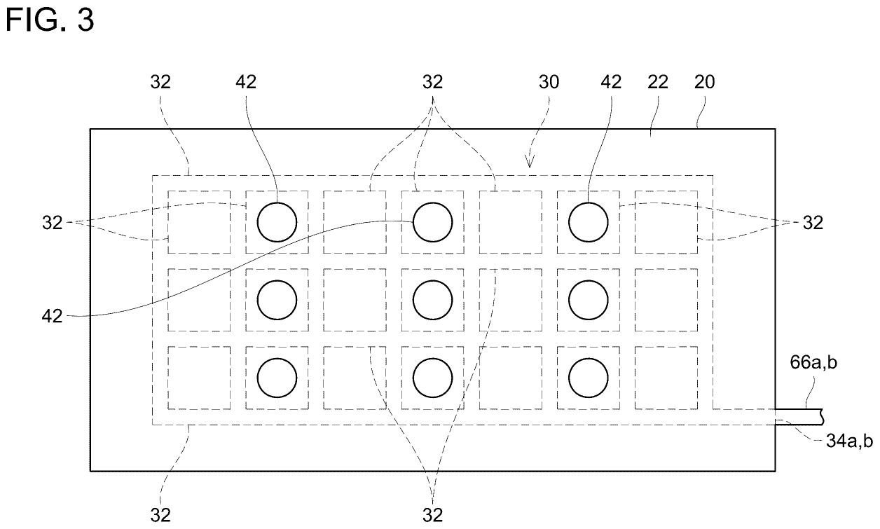

The case 20 further comprises a liquid passage 30 configured to allow liquid to flow therein. The liquid passage 30 is provided for example in the top surface member 22 and the bottom surface member 24 of the case 20. The liquid passage 30 is disposed around the battery 10. As illustrated in FIGS. 2 and 3, the liquid passage 30 comprises a plurality of passages 32. The plurality of passages 32 is arranged in a grid, for example. Each passage 32 is arranged to cross the battery 10 laterally or vertically above and below the battery 10.

The liquid passage 30 comprises a plurality of inlet ports 34a, 34b for introducing the extinguishing liquid into the liquid passage 30. The inlet ports 34a, 34b for the extinguishing liquid are disposed on for example a side surface of the top surface member 22 of the case 20 and on a side surface of the bottom surface member 24 of the case 20. These inlet ports 34a, 34b are respectively connected to the passages 66a, 66b of the inlet passage 66. The extinguishing liquid is introduced into the liquid passage 30 via the inlet passage 66 and the inlet ports 34a, 34b.

The extinguishing liquid introduced into the liquid passage 30 is for example water. The extinguishing liquid introduced into the liquid passage 30 may contain extinguisher agents. As the extinguisher agents, sodium hydrogen carbonate, potassium bicarbonate, ammonium phosphate, halide extinguishing compound may be exemplified. Here, the extinguishing liquid introduced into the liquid passage 30 may be liquid other than water.

As illustrated in FIG. 1, another end of the inlet passage 66 is for example secured to the body of the vehicle 4. A liquid supply connector 68 is attached to the other end of the inlet passage 66. A liquid sending connector 60 of the external device 8 is connected to the liquid supply connector 68. The inlet passage 66 also includes a liquid supply valve 70. The liquid supply valve 70 opens for example when the liquid sending connector 60 is connected to the liquid supply connector 68, and closes when the liquid sending connector 60 is removed from the liquid supply connector 68. The liquid supply valve 70 opens and closes the inlet passage 66.

As illustrated in FIG. 2, the liquid passage 30 disposed in the case 20 comprises a plurality of discharge ports 36 configured to discharge the extinguishing liquid toward the battery 10 within the case 20. The plurality of discharge ports 36 is for example arranged on the top surface member 22 of the case 20 and the bottom surface member 24 of the case 20. The plurality of discharge ports 36 is open on sides of the top surface member 22 and the bottom surface member 24 that are on a battery 10 side (sides facing the battery 10). The plurality of discharge ports 36 is arranged at intervals. Each discharge port 36 is sealed by sealing 40 under the normal times (when there is no fire occurring in the battery 10).

A plurality of drain ports 38 is arranged on the top surface member 22 of the case 20. The plurality of drain ports 38 penetrates the top surface member 22. The plurality of drain ports 38 is arranged at intervals. Each drain port 38 is sealed by sealing 42 under the normal times (when there is no fire occurring in the battery 10).

The sealing 40 which seals the discharge ports 36 is arranged on the sides of the top surface member 22 and the bottom surface member 24 of the case 20 that are on the battery 10 side. The sealing 40 is applied on the top surface member 22 and the bottom surface member 24. The sealing 40 is constituted of a material which melts at a predetermined melting temperature Tx or higher. For example, the sealing 40 is constituted of a material containing zinc which melts at approximately 420°. When the sealing 40 has molten, the discharge ports 36 are opened. Due to this, the extinguishing liquid within the liquid passage 30 is discharged from the discharge ports 36 toward the battery 10. Under a state where a pressure within the liquid passage 30 is high, the extinguishing liquid within the liquid passage 30 is ejected from the discharge ports 36 toward the battery 10. If the battery 10 is on fire, the extinguishing liquid discharged from the discharge ports 36 extinguishes the fire of the battery 10.

The sealing 42 which seals the drain ports 38 is attached on a side of the top surface member 22 of the case 20 that is opposite from the battery 10. The sealing 42 is applied on the top surface member 22. When the pressure of the extinguishing liquid within the case 20 becomes higher than a predetermined pressure, the sealing 42 is torn off from the drain ports 38 by the pressure. Due to this, the drain ports 38 are opened, by which the extinguishing liquid within the case 20 is drained through the drain ports 38 out of the case 20.

Next, the external device 8 (see FIG. 1) of the fire extinguishing system 2 will be described. The external device 8 comprises a charging device 50 and a liquid supply device 52. The charging device 50 is connected to for example a commercial power source (not illustrated), and supplies the power supplied from the commercial power source to the battery 10 of the vehicle 4. The charging device 50 is a device configured to charge the battery 10 of the vehicle 4.

The charging device 50 comprises a power transmission cable 54 and the power transmission connector 56. When the battery 10 of the vehicle 4 is to be charged, the power transmission connector 56 of the charging device 50 is connected to the charging connector 64 of the internal device 6. The power transmission connector 56 and the charging connector 64 have for example a coupler-type configuration comprising a plug and a socket. The specific configurations of the power transmission connector 56 and the charging connector 64 are not limited in particular.

The power transmission cable 54 is connected to the charging cable 62 via the power transmission connector 56 and the charging connector 64. The power transmission cable 54 transmits the power supplied from the commercial power source via the power transmission connector 56 and the charging connector 64 to the charging cable 62. The power is supplied through the power transmission cable 54 and the charging cable 62 to the battery 10 of the vehicle 4. Due to this, the battery 10 is charged.

The liquid supply device 52 is connected to a fire hydrant (not illustrated), and supplies the extinguishing liquid supplied from the fire hydrant to the case 20 accommodating the battery 10 of the vehicle 4. The extinguishing liquid supplied from the liquid supply device 52 is introduced into the liquid passage 30 arranged in the case 20.

The liquid supply device 52 comprises a liquid sending hose 58 and the liquid sending connector 60. When the extinguishing liquid is to be supplied to the liquid passage 30, the liquid sending connector 60 of the liquid supply device 52 is connected to the liquid supply connector 68 of the internal device 6. The liquid sending connector 60 and the liquid supply connector 68 have for example a coupler-type configuration comprising a plug and a socket. The specific configurations of the liquid sending connector 60 and the liquid supply connector 68 are not limited in particular.

The liquid sending hose 58 is connected to the inlet passage 66 via the liquid sending connector 60 and the liquid supply connector 68. The liquid sending hose 58 sends the extinguishing liquid supplied from the fire hydrant via the liquid sending connector 60 and the liquid supply connector 68 to the inlet passage 66. The extinguishing liquid is supplied through the liquid sending hose 58 and the inlet passage 66 to the liquid passage 30.

Next, a method of extinguishing fire of the battery 10 by the above-described fire extinguishing system 2 will be described. In the battery 10 mounted in the vehicle 4, fire may occur when the battery 10 is excessively heated while the battery 10 is being charged, for example. When a fire occurs in the battery 10 in the above-mentioned fire extinguishing system 2, the case 20 accommodating the battery 10 is heated to a high temperature. In addition, as the sealing 40 sealing the discharge ports 36 arranged in the case 20 is heated to a high temperature, the sealing 40 melts. As a result, the discharge ports 36 are opened, and the extinguishing liquid within the liquid passage 30 is discharged from the discharge ports 36 toward the battery 10. Due to this, the fire of the battery 10 is extinguished. The extinguishing liquid discharged from the discharge ports 36 is retained inside the case 20. Further, when the pressure of the extinguishing liquid within the case 20 becomes higher than a predetermined pressure, the extinguishing liquid within the case 20 is drained through the plurality of drain ports 38 out of the case 20.

Further, in the above-mentioned fire extinguishing system 2, by connecting the liquid sending hose 58 of the external device 8 to the inlet passage 66 of the internal device 6, the extinguishing liquid can be supplied to the case 20 accommodating the battery 10 from the liquid supply device 52 of the external device 8. The extinguishing liquid supplied from the liquid supply device 52 to the case 20 is introduced into the liquid passage 30 arranged in the case 20. The extinguishing liquid introduced into the liquid passage 30 is discharged from the discharge ports 38 of the case 20 toward the battery 10. Due to this, the fire of the battery 10 is extinguished.

### Effects

As above, the fire extinguishing system 2 according to the first embodiment was described. As is apparent from the foregoing description, the fire extinguishing system 2 comprises: the case 20 accommodating the battery 10 and the sealing 40 which seals the discharge ports 36 disposed in the case 20. The case 20 comprises the liquid passage 30 arranged around the battery 10. The sealing 40 melts at the predetermined melting temperature Tx or higher to open the discharge ports 36. The extinguishing liquid within the liquid passage 30 is discharged from the discharge ports 36 toward the battery 10.

According to this configuration, when fire occurs in the battery 10, the sealing 40 is heated to a significantly high temperature and melts, as a result of which the discharge ports 36 are opened, and the extinguishing liquid within the liquid passage 30 is discharged from the discharge ports 36 toward the battery 10. Due to this, the fire of the battery 10 can be extinguished. In the meantime, when there is no fire occurring in the battery 10, the discharge ports 36 are kept sealed by the sealing 40, and the extinguishing liquid within the liquid passage 30 can be suppressed from being discharged toward the battery 10. When there is no fire occurring in the battery 10, the battery 10 can be suppressed from being wet with the extinguishing liquid. Also, when there is no fire occurring in the battery 10, the extinguishing liquid within the liquid passage 30 can cool the battery 10, by which it is possible to prevent fire from occurring in the battery 10.

The fire extinguishing system 2 further comprises the inlet passage 66 connected to the liquid passage 30 via the inlet ports 34a, 34b. Also, the fire extinguishing system 2 further comprises the external device 8 which is not mounted in the vehicle 4 and configured to introduce the extinguishing liquid into the liquid passage 30 via the inlet passage 66 and the inlet ports 34a, 34b. According to such configuration, when a fire occurs in the battery 10, the extinguishing liquid can be additionally introduced from the external device 8 into the liquid passage 30. Due to this, fire extinguishing capability can be improved.

The fire extinguishing system 2 further comprises the liquid supply valve 70 configured to open and close the inlet passage 66. According to such configuration, by closing the liquid supply valve 70 when there is no fire occurring in the battery 10, the extinguishing liquid within the liquid passage 30 can be suppressed from flowing out. Also, when a fire is occurring in the battery 10, the liquid supply valve 70 can be opened and the extinguishing liquid can be introduced through the inlet passage 66 into the liquid passage 30. Due to this, fire extinguishing capability can be improved.

The external device 8 comprises the charging device 50 configured to charge the battery 10. According to such configuration, when there is no fire occurring in the battery 10, the battery 10 can be charged by the external device 8. Further because the external device 8 comprises the charging device 50 and the liquid supply device 52, it is possible to be prepared against fire during charging of the battery 10.

As mentioned above, the first embodiment was described, but specific configurations of the fire extinguishing system 2 are not limited to the above embodiment. In the following description, a detailed description may be omitted for the same configurations as those in the above description, by using like numerals or signs for the same configurations.

### Second Embodiment

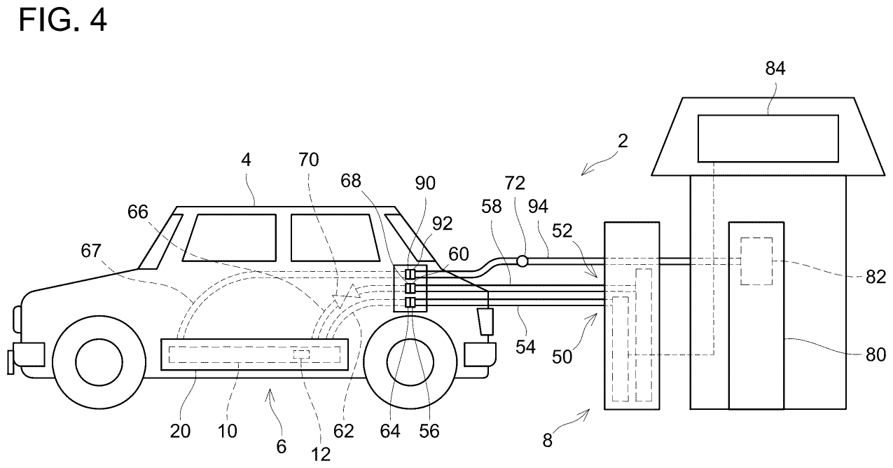

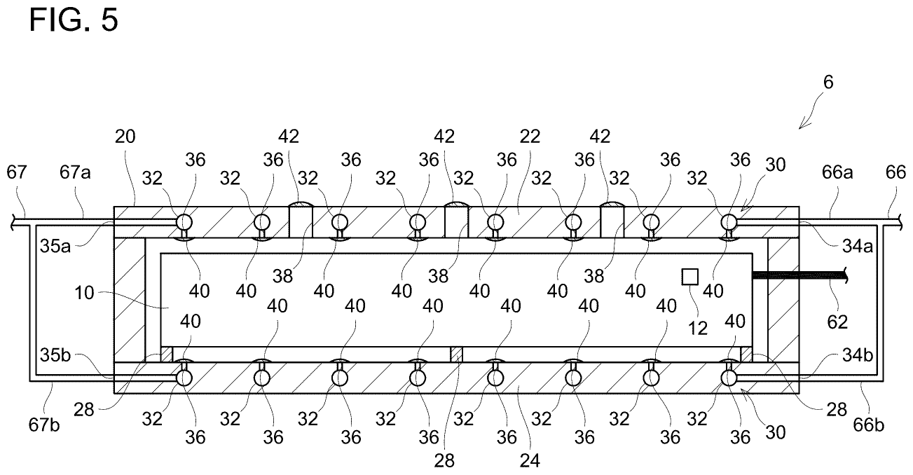

A fire extinguishing system according to a second embodiment will be described with reference to drawings. As illustrated in FIGS. 4 and 5, in a fire extinguishing system 2 of the second embodiment, the internal device 6 comprises a temperature sensor 12 configured to detect the temperature of the battery 10. The temperature sensor 12 is attached on for example a surface of the battery 10. In a modification, the temperature sensor 12 may be disposed in proximity to the battery 10. Information of a detected temperature by the temperature sensor 12 is sent to the external device 8 via a wireless communication or a wired communication.

The internal device 6 of the second embodiment comprises an outlet passage 67 connected to the case 20 of the battery 10. An upstream end of the outlet passage 67 branches into two passages 67a, 67b, in which one passage 67a is connected to the top surface member 22 of the case 20 and the other passage 67b is connected to the bottom surface member 24 of the case 20.

The case 20 of the battery 10 comprises a plurality of outlet ports 35a, 35b for leading the extinguishing liquid within the liquid passage 30 out of the liquid passage 30. The outlet ports 35a, 35b for the extinguishing liquid are disposed for example on a side surface of the top surface member 22 of the case 20 and a side surface of the bottom surface member 24. The passages 67a, 67b of the outlet passage 67 are respectively connected to these outlet ports 35a, 35b. The extinguishing liquid within the liquid passage 30 is led out of the liquid passage 30 via the outlet ports 35a, 35b and the outlet passage 67.

A downstream end of the outlet passage 67 is secured to for example a body of the vehicle 4. The liquid drain connector 90 is attached to the downstream end of the outlet passage 67. A recovery connector 92 of a thermal device 80 to be described later is connected to the liquid drain connector 90.

The fire extinguishing system 2 of the second embodiment further comprises the thermal device 80 and a generator 84. The thermal device 80 is for example a water heater device, an air heating device or an air-cooling device installed in a house. The thermal device 80 comprises a recovery hose 94, the recovery connector 92, and a heat exchanger 82.

When the extinguishing liquid is to be recovered from the liquid passage 30 of the case 20, the recovery connector 92 of the thermal device 80 is connected to the liquid drain connector 90 of the internal device 6. The recovery connector 92 and the liquid drain connector 90 have for example a coupler-type configuration comprising a plug and a socket. The specific configurations of the recovery connector 92 and the liquid drain connector 90 are not limited in particular.

An upstream end of the recovery hose 94 is connected to the outlet passage 67 of the internal device 6 via the recovery connector 92 and the liquid drain connector 90. A downstream end of the recovery hose 94 is connected to the heat exchanger 82 of the thermal device 80. The recovery hose 94 sends the extinguishing liquid led through the outlet passage 67 out of the liquid passage 30 of the case 20 to the heat exchanger 82. The extinguishing liquid is supplied through the outlet passage 67 and the recovery hose 94 to the heat exchanger 82. The recovery hose 94 comprises a pump 72 configured to pump the extinguishing liquid flowing in the recovery hose 94 toward the heat exchanger 82.

The heat exchanger 82 is connected to the recovery hose 94 and exchanges heat between the extinguishing liquid recovered from the internal device 6 through the recovery hose 94 and the heat medium of the thermal device 80. The heat exchanger 82 uses for example a heat pump technique to exchange heat between the extinguishing liquid and the heat medium. For example, the heat exchanger 82 cools the extinguishing liquid and also heats the heat medium in the heat exchange between the extinguishing liquid and the heat medium. In a modification, the heat exchanger 82 may heat the extinguishing liquid and also cool the heat medium in the heat exchange between the extinguishing liquid and the heat medium. Here, because the heat pump technique is already known, and thus its detailed description is omitted.

The extinguishing liquid the heat of which was exchanged by the heat exchanger 82 may be again supplied to the internal device 6 via the liquid supply device 52 of the external device 8. In a modification, the extinguishing liquid the heat of which was exchanged by the heat exchanger 82 may be recovered by another recovery facility.

The generator 84 is for example a photovoltaic power generator installed on a roof of a house. In a modification, the generator 84 may be a wind-power generator. The generator 84 generates power by renewable energy such as solar power or wind power. The generator 84 is electrically connected to the charging device 50 of the fire extinguishing system 2, and supplies the generated power to the charging device 50. The charging device 50 can charge the battery 10 with power generated by the generator 84.

The charging device 50 of the second embodiment is configured to charge the battery 10 in one of a normal charging mode and a rapid charging mode in which the battery 10 is charged more quickly than in the normal charging mode. An output of the charging device 50 in the rapid charging mode is greater than an output of the charging device 50 in the normal charging mode. The charging device 50 is configured to switch between the normal charging mode and the rapid charging mode depending on the temperature of the battery 10. For example when the temperature of the battery 10 detected by the temperature sensor 12 is within a predetermined threshold temperature range (e.g., the detected temperature of the temperature sensor 12 is 5° C. or higher and 45° C. or lower), the charging device 50 charges the battery 10 in the rapid charging mode. On the other hand, when the temperature of the battery 10 detected by the temperature sensor 12 is out of the predetermined threshold temperature range (e.g., when the detected temperature of the temperature sensor 12 is 5° C. or lower or 45° C. or higher), the charging device 50 charges the battery 10 in the normal charging mode.

In the fire extinguishing system 2 of the second embodiment, the liquid supply device 52 of the external device 8 changes a flow rate of the extinguishing liquid to be supplied to the case 20 of the battery 10 according to the charging mode of the charging device 50. For example, when the charging device 50 charges the battery 10 in the normal charging mode, the liquid supply device 52 supplies the extinguishing liquid to the case 20 at a first flow rate. Due to this, the extinguishing liquid is introduced at the first flow rate into the liquid passage 30 arranged in the case 20. The extinguishing liquid is introduced into the liquid passage 30 from the liquid supply device 52 through the liquid sending hose 58 and the inlet passage 66.

On the other hand, when the charging device 50 charges the battery 10 in the rapid charging mode, the liquid supply device 52 supplies the extinguishing liquid to the case 20 at a second flow rate. Due to this, the extinguishing liquid is introduced into the liquid passage 30 at the second flow rate. The second flow rate is greater than the first flow rate.

As above, the fire extinguishing system 2 of the second embodiment was described. As is apparent from the above description, in the second embodiment, when charging the battery 10, the charging device 50 is configured to charge the battery 10 in one of the normal charging mode and the rapid charging mode in which the battery 10 is charged more quickly than in the normal charging mode. The charging device 50 charges the battery 10 in the rapid charging mode when the temperature detected by the temperature sensor 12 is within the predetermined threshold temperature range, and charges the battery 10 in the normal charging mode when the temperature detected by the temperature sensor 12 is outside the predetermined threshold temperature range.

The battery 10 tends to have a greater allowable power for charging when the temperature is within the threshold temperature range and have a smaller allowable power for charging when the temperature is outside the threshold temperature range. According to the above configuration, the battery 10 is charged in the rapid charging mode when the allowable power for charging is great, by which the battery 10 can be effectively charged. Contrary to this, even if the battery 10 is charged in the rapid charging mode when the allowable power for charging of the battery is small, energy loss would occur. According to such a configuration, however, because the battery 10 is charged in the normal charging mode when the allowable power for charging of the battery is small, the wasteful energy loss can be reduced and thus the battery 10 can be effectively charged.

As to the external device 8 of the second embodiment, when the charging device 50 charges the battery 10 in the normal charging mode, the liquid supply device 52 introduces the extinguishing liquid into the liquid passage 30 at the first flow rate, and when the charging device 50 charges the battery 10 in the rapid charging mode, the liquid supply device 52 introduces the extinguishing liquid into the liquid passage 30 at the second flow rate that is greater than the first flow rate.

When the battery 10 is charged in the rapid charging mode, the temperature of the battery 10 tends to be higher because high power is supplied to the battery 10. Contrary to this, when the battery 10 is charged in the normal charging mode, heat generation in the battery 10 tends to be suppressed. According to such configuration, the temperature of the battery 10 can be suppressed low because a great amount of the extinguishing liquid can be introduced when the temperature of the battery 10 is higher. Contrary to this, when the heat generation in the battery 10 is suppressed, a small amount of the extinguishing liquid is introduced, as a result of which the extinguishing liquid can be suppressed from being wastefully consumed.

The fire extinguishing system 2 of the second embodiment further comprises the thermal device 80. The thermal device 80 comprises: the recovery hose 94 configured to recover the extinguishing liquid led out from the liquid passage 30 of the case 20; the heat exchanger 82 configured to exchange heat between the extinguishing liquid recovered by the recovery hose 94 and heat medium of the thermal device 80; and the pump 72 configured to pump the extinguishing liquid to the heat exchanger 82 through the recovery hose 94.

The extinguishing liquid introduced into the liquid passage 30 disposed around the battery 10 is heated by the heat of the battery 10. According to such configuration, the heat medium of the thermal device 80 can be heated by using the heat of the extinguishing liquid heated by the heat of the battery 10. Also, the extinguishing liquid can be cooled. Alternatively, the extinguishing liquid can be heated using the heat of the heat medium of the thermal device 80. Due to this, the temperature of the battery 10 can be controlled to a temperature suitable for charging. Further, the heat of the battery 10 can be effectively utilized.

The charging device 50 charges the battery 10 using renewable energy. According to such configuration, the renewable energy can be effectively utilized, and thus power efficiency can be improved.

### Modifications

(1) Although in the above embodiments the liquid supply device 52 is connected to the fire hydrant, the present teachings are not limited to this configuration. In a modification, the upstream end of the liquid sending hose 58 of the liquid supply device 52 may be connected to a hose of a fire engine. The liquid supply device 52 may be configured to such that the extinguishing liquid supplied from the fire engine is introduced into the liquid passage 30 of the case 20.

(2) The liquid supply device 52 may comprise a notifier (not illustrated). When the liquid supply device 52 supplies the case 20 with the extinguishing liquid, the notifier may notify the surroundings of notifying information (e.g., sound and/or light) which notifies the supply of the liquid. For example, the notifier may emit siren when the liquid supply device 52 supplies the extinguishing liquid.

The liquid supply valve 70 disposed in the inlet passage 66 may be configured to open when the temperature of the battery 10 is at a melting temperature Tx or higher. The temperature of the battery 10 is detected, for example, by a temperature sensor (not illustrated) attached on the battery 10. When the temperature of the battery 10 is at the melting temperature Tx or higher, by which a temperature of the sealing 40 becomes the melting temperature Tx or higher, and as a result of this, the sealing 40 melts and the discharge ports 36 are opened. Accordingly, the liquid supply valve 70 is opened with the discharge ports 36 opened. Due to this, the extinguishing liquid supplied to the case 20 through the inlet passage 66 can be discharged from the discharge ports 36 toward the battery 10.

(4) Although in the above embodiments the internal device 6 of the fire extinguishing system 2 is mounted in the vehicle 4, the present teachings are not limited to this configuration. In a modification, the internal device 6 of the fire extinguishing system 2 may be mounted on/in another movable body (e.g., ship, airplane). In another modification, the internal device 6 of the fire extinguishing system 2 may not be mounted on/in a movable body. For example, the internal device 6 of the fire extinguishing system 2 may be a stationary configuration installed on/in a house or a factory, for example.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A fire extinguishing system configured to extinguish fire of a battery, the system comprising:
a case accommodating the battery and including a liquid passage arranged around the battery, an inlet port configured to introduce extinguishing liquid into the liquid passage, and a discharge port configured to discharge the extinguishing liquid within the liquid passage toward the battery; and
sealing which seals the outlet, wherein the sealing melts at a temperature equal to or higher than a predetermined melting temperature to open the discharge port.

2. The fire extinguishing system according to claim 1, further comprising:
an inlet passage connected to the liquid passage via the inlet port; and
an external device configured to introduce the extinguishing liquid into the liquid passage via the inlet passage and the inlet port.

3. The fire extinguishing system according to claim 2, further comprising:
a valve configured to open and close the inlet passage.

4. The fire extinguishing system according to claim 2, wherein the external device comprises a charging device configured to charge the battery.

5. The fire extinguishing system according to claim 4, further comprising:
a temperature sensor configured to detect a temperature of the battery,
wherein the external device introduces the extinguishing liquid into the liquid passage when the charging device charges the battery,
when charging the battery, the charging device is configured to charge the battery in one of a normal charging mode and a rapid charging mode in which the battery is charged more quickly than in the normal charging mode, and
the charging device charges the battery in the rapid charging mode when the temperature detected by the temperature sensor is within a predetermined threshold temperature range, and charges the battery in the normal charging mode when the temperature detected by the temperature sensor is outside the predetermined threshold temperature range.

6. The fire extinguishing system according to claim 5, wherein when the charging device charges the battery in the normal charging mode, the external device introduces the extinguishing liquid into the liquid passage at a first flow rate, and when the charging device charges the battery in the rapid charging mode, the external device introduces the extinguishing liquid into the liquid passage at a second flow rate that is greater than the first flow rate.

7. The fire extinguishing system according to claim 1, further comprising:
a thermal device, wherein the thermal device comprises:
a recovery hose configured to recover the extinguishing liquid led out from the liquid passage;
a heat exchanger configured to exchange heat between the extinguishing liquid recovered by the recovery hose and heat medium of the thermal device; and
a pump configured to pump the extinguishing liquid to the heat exchanger through the recovery hose.

8. The fire extinguishing system according to claim 4, wherein the charging device charges the battery using renewable energy.
